(19) United States
(12) Patent Application Publication
(10) Pub. No.: US 2006/0074614 A1
(43) Pub. Date: Apr. 6, 2006

(54) Apparatus and method for virtual prototyping of blow molded objects

(76) Inventors: Long Fei Chang, Sylvania, OH (US); Sumit Mukherjee, Sylvania, OH (US); Frank E Semersky, Holland, OH (US)

Correspondence Address: FRASER MARTIN & MILLER LLC, 132 WEST SECOND STREET, PERRYSBURG, OH, 43551, US

(21) Appl. No.: 10/540,427

(22) PCT Filed: Jan. 20, 2004
(86) PCT No.: PCT/US04/01376

§ 371 Date: Jun. 23, 2005

Related U.S. Application Data
(60) Provisional application No. 60/441,419, filed on Jan. 21, 2003.

(51) Int. Cl. G06G 7/48

(52) U.S. Cl. 703/6

(57) ABSTRACT

A method is provided for simulating the heating of a plastic preform. A preform geometry is input into a preform design program. Oven geometry and spatial location of the preform throughout at least one oven is provided. Heating information is provided and the temperatures of the primary and secondary sources are calculated. Energy equations are solved based upon the preform geometry, the spatial location of the preform, the temperature the cooling air, and the absorption spectra of the preform material. At least one cross sectional thermal profile of a final heated preform is computed.

### CROSS REFERENCE TO RELATED APPLICATIONS

This application claims the benefit of U.S. provisional patent application Ser. No. 60/441,419 filed Jan. 21, 20031.

### STATEMENT REGARDING FEDERALLY SPONSORED RESEARCH

Not Applicable.

### BACKGROUND OF THE INVENTION

1. Field of the Invention

The present invention relates generally to the design of blow molded objects and, in particular, to an apparatus and method for simulating the heating of a plastic preform.

2. Description of the Related Art

Blow-molding operations typically involve encapsulating a heated plastic material such as a preform within the interior of a mold, applying a pressure to the interior of the preform so as to expand the preform against the mold cavity to form an article of manufacture. Issues concerning blow-molding operations involve the expansion of the material to the final desired shape. Expansion factors such as undesired thinning of certain areas of the article of manufacture leads to further re-tooling of the mold in those critical areas to reduce the effects of the unwanted expansion and thinning. This trial and error process becomes costly as new mold and/or performs need to be designed and created. Furthermore, run times for producing prototypes of the actual article are typically costly.

To reduce trial and error and to reduce the time of design to production, computer aided design has been used for designing of the mold. U.S. Pat. No. 5,458,825 describes a method for producing a prototype of a blow molded item by generating a data file of the geometry and contours for the inner cavity of a mold utilizing a computer aided design (CAD) apparatus. The data file is used to create the mold from photosensitive resin utilizing a stereolithographic apparatus. U.S. Pat. No. 6,116,888 describes utilizing CAD software to design a hollow plastic container. The software model is used to generate a software model of the corresponding mold. The mold data file controls a cutting tool to machine the mold.

However, these and other software design tools fail to take into consideration a combination of factors such as temperature affects of all heating and cooling sources upon the entire preform, the stress/strain behavior of the material throughout the molding process, and the energy incident to the preform during the entire molding process.

### SUMMARY OF THE INVENTION

The present invention has the advantage of simulating a heating of a plastic preform to determine one or more cross sectional thermal profiles of a final heated preform for modeling or virtually prototyping plastic containers.

A method is provided for simulating a heating of a plastic preform. A preform geometry is input into a preform design program. Oven geometry and spatial location of the preform throughout at least one oven is provided. Heating information is provided and the temperatures of the-primary and secondary sources are calculated. Energy equations are solved based upon the preform geometry, the spatial location of the preform, the temperature the cooling air, and the absorption spectra of the preform material. At least one cross sectional thermal profile of a final heated preform is computed.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a flow diagram of the method of virtual prototyping in accordance with the present invention.

FIG. 2 is an illustration of secondary sources emitting radiation to the preform in accordance with the present invention.

FIG. 3 is an illustration of a preform transitioning along an oven showing the preform at various locations within the oven incident to heating sources.

FIG. 4 is an illustration of a preform discretized into a plurality of blocks in accordance with the present invention.

FIG. 5 is an illustration of the discretized preform incident to the direct exposure and viewing angle of the heating sources in accordance with the present invention.

FIG. 6 is an illustration of the preform discretized at critical locations indicating transitional changes to a shape of the preform in accordance with the present invention.

FIG. 7 is an illustration of the preform discretized into a plurality of intermediary sections according in accordance with the present invention.

FIG. 8 is a graph of a stress vs. axial stretch for a respective material in accordance with the present invention.

FIG. 9 is a graph of a stretch vs. blow pressure of a tube for the respective material in accordance with the present invention.

### DESCRIPTION OF THE PREFERRED EMBODIMENT

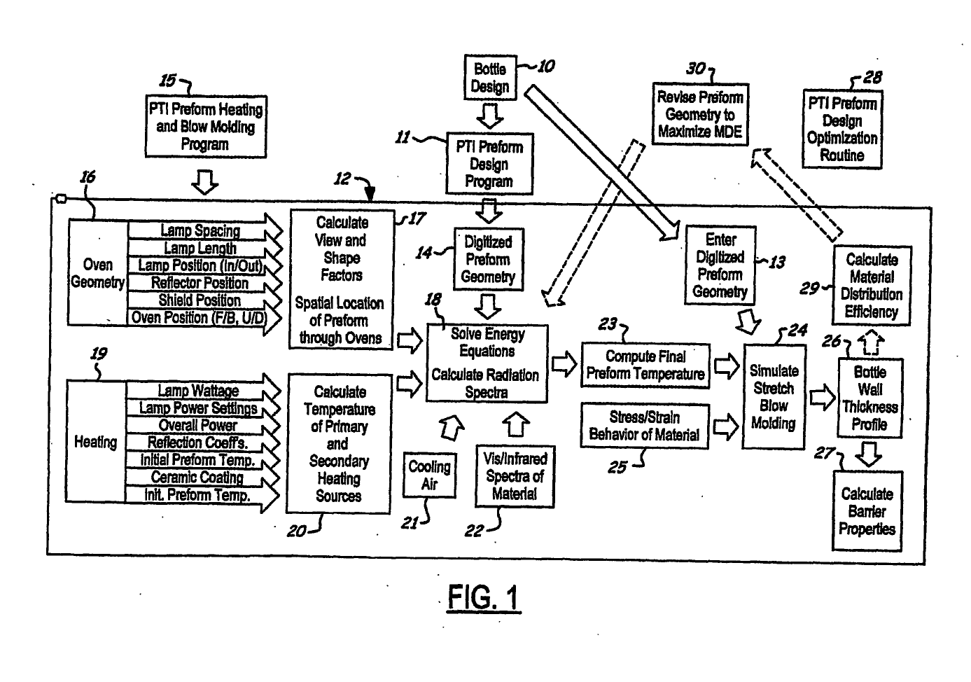

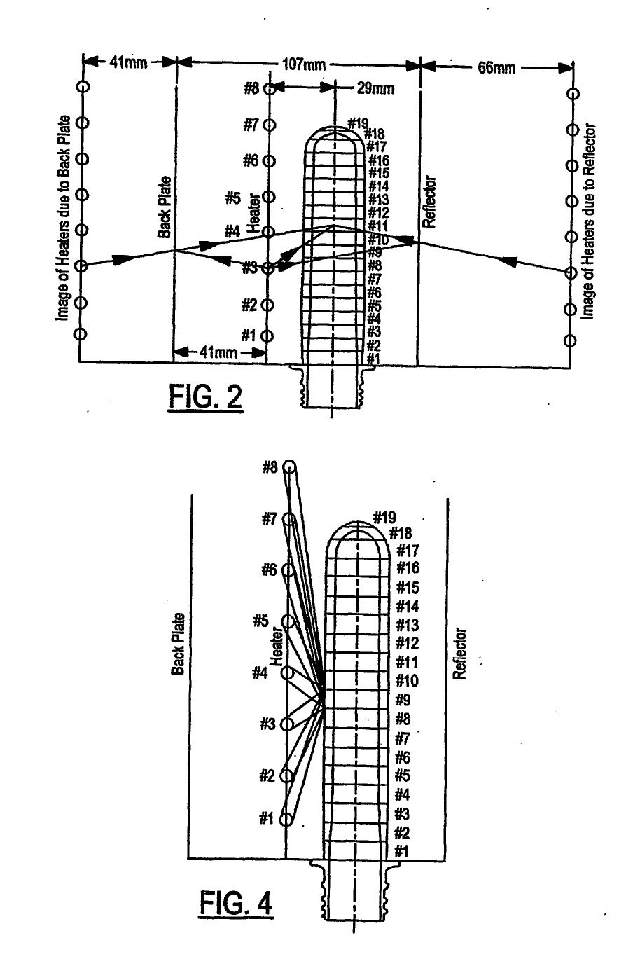

There is shown in FIG. 1 a flow diagram of the method of virtual prototyping of plastic containers in accordance with the present invention. The method can be implemented in software run on a computer. In a first step 10, a container (e.g., bottle) design is created by any known process thereby generating bottle geometry data. This data is entered in digitized form into a Preform Design Program 11 to generate digitized preform geometry. Inputs to the program 11 are the bottle geometry, the container and finish weight and the resin stretching characteristic. Preform designs are created so the designs may be stripped off of a core (i.e., error checking for undercuts) and positions of transition regions of the preform may be adjusted so that shoulder regions of the preform coincides with that of the bottle, if desired. A virtual prototyping module 12 receives the digitized bottle geometry in a step 13 and the digitized preform geometry in a step 14. A Preform Heating and Blow Molding Program 15 simulates the heating and the blowing of the preform into a prototype bottle. An Oven Geometry step 16 defines the parameters of one or more ovens which parameters are input into a Calculate View and Shape Factors step 17 resulting in the spatial location of the preform through the ovens. Oven geometry parameters include lamp spacing, lamp length, lamp position, reflector position, shield position, and oven position. The spatial location is an input to a Solve Energy Equations step 18 as is the digitized preform geometry from the step 14.

A Heating step 19 defines the parameters of the heating sources which parameters are input into a Calculate Temperature of Primary and Secondary Heating Sources step 20. Heating parameters include lamp wattage, lamp power settings, overall power, reflection coefficients, initial preform temperature, ceramic coating, and initial preform temperature. A heating preform module solves energy equations and computes at least one cross sectional thermal profile of a final heated preform. The temperatures from the step 20 are input into the Solve Energy Equations step 18 as are Cooling Air parameters (step 21) and Vis/Infrared Spectra of Material parameters (step 22). The step 18 calculates the radiation spectra to determine the energy incident upon the preform which information is input to a Compute Final Preform Temperature step 23. To calculate the radiation spectra in step 18, the power input to the lamps and their emission spectra is used for calculating the temperature of the lamps. One of the inputs comprises a filament enhancement factor which corrects for any lamp element shielding. Secondary sources of radiation like the temperatures of a backplate and reflectors within the oven are calculated from energy received and appropriate reflection coefficients of the back plates and reflectors, respectively. Radiation energy (E) from the heater at Temperature (T) and emissivity (ξ) to a respective area (Aₚ) on the preform between wavelengths λ and δλ is calculated using Planck's theory of quantum statistical thermodynamics given by the equation:

$$Ej = \frac{( {B}_{j + 1} - {B}_{j} )}{[ {ⅇ}^{( \frac{14400}{T \cdot {WL}_{j}} )} - 1 ]} \cdot \frac{8950}{[ {( {WL}_{j} )}^{5} ]}$$

where T is a temperature measured in degrees Kelvin
Bⱼ₊₁−Bⱼδλ
WL is a wavelength measured in microns

The above equation is used determine the total energy emitted for an entire range of wavelengths. The values derived from the above equation when multiplied by the emissivity of the lamps provides a real/gray body radiation output that is used as the energy incident upon the preform for absorption calculations.

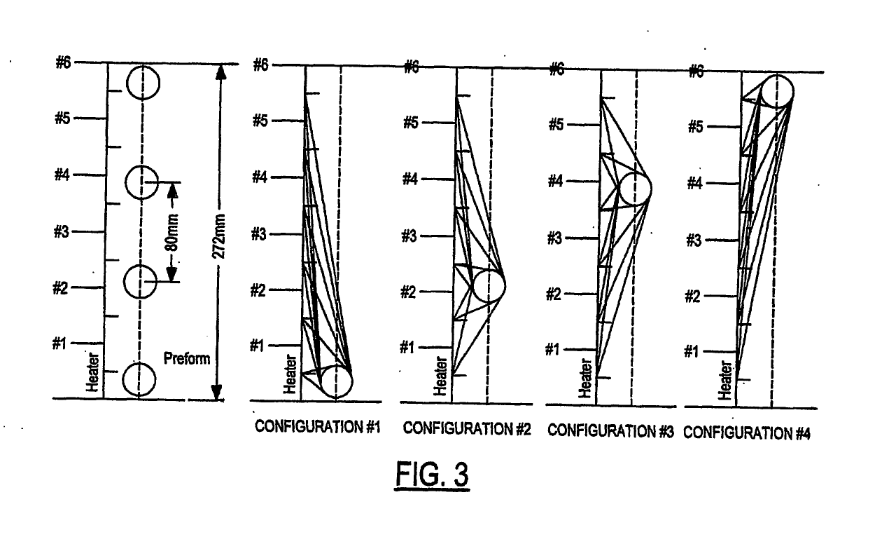

The preform infrared spectra are input as absorption values for the different wavelengths in an infrared region of the electromagnetic spectrum. Also, the travel of the preform through the ovens is discretized into steps. A portion of the calculation involves determining time spent at each respective step in the oven and the exposure of the preform to each respective lamp a respective step (shown in FIG. 3). This indicates that regions closer to the lamp would have a greater amount of energy incident upon it. The inputted preform geometry is discretized (or digitized) into a plurality of small rectangular blocks having a respective volume (shown in FIG. 4). An amount of energy absorbed into each discretized block is calculated and utilized for a temperature calculation. Also, radiation transmitted through a respective discretized block is used in calculating the energy incident and absorbed in a next adjacent discretized block. The radiation absorbed by each respective discretized block is incident to the direct exposure or viewing angle of each lamp as each respective discretized block travels through the oven (FIG. 5). Since each respective lamp will have a respective viewing angle of a respective discretized block at any given step throughout the oven, a view factor for each discretized block at any given step in the oven may be determined using the following formula:
V_{f}=(1/π)∫dAₚ∫ Cos φ Cos θdAₕ/r²

where Aₚ=Area of Preform
Aₕ=Area of Heater
φ=Angle between normal to preform surface and incremental area on heater
θ=Angle between normal to heater surface and incremental area on preform
r=distance between the heater surface to the preform surface (Aₚ to Aₕ)

The temperature of each discretized block of the preform is calculated by solving a second order differential heat transfer equation involving an energy balance which accounts for radiation energy input thermal conductivity of the material of the preform as a means for transmitting the energy axially and radially.

Furthermore, other factors accounted for are any boundary effects of cooling convective air current on an outer surface of the preform as well as a relatively insulated inner surface of the preform. The computation is repetitiously performed until energy balance is achieved.

In the preferred embodiment, the second order heat transfer differential equation is represented by the following formula:

$$k * \frac{{ⅆ}^{ 2}}{ⅆ {r}^{2}} T + \frac{k}{r} * \frac{ⅆ}{ⅆ r} T + \frac{Q}{A} = ρ * C * \frac{ⅆ}{ⅆ τ} T Units of Cal \text{/} cc * s$$

where A=2πrΔr (i.e., an area of incremental ring at radius r and thickness Δr), Q represents an energy generation term (i.e., energy per second per cm of preform sidewall thickness), τ is representative of time, ρ represents the density of the plastic, and k is the thermal conductivity of the plastic.

The thermal conductivity constant (k) is represented by CD and ρC is represented by HCD (Cal/cc*K). The heat capacity (HCD) is a function of temperature. By substituting these terms in the above equation, the formula becomes:

$$CD * \frac{{ⅆ}^{ 2}}{ⅆ {r}^{2}} T + \frac{CD}{r} * \frac{ⅆ}{ⅆ r} T + \frac{Q}{A} = HCD ( T ) * \frac{ⅆ}{ⅆ τ} T$$

which is subject to the following boundary conditions for the inside and outside surfaces of the preform which are exposed to air. The boundary conditions are represented by the following formulas:

$$\begin{matrix}- ( \frac{ⅆ}{ⅆ x} T ) ) * k = h * ( T - T α ) , which leads to \\ ( \frac{- k ( {T}_{i} - {T}_{i - 1} )}{Δ x} ) = h * ( {T}_{i} - T α ) , which leads to \\ {T}_{i} = \frac{( {T}_{i - 1} + h * \frac{Δ x}{k} * T α )}{1 + h * \frac{Δ x}{k}} ,\end{matrix}$$

where Tᵢ is a wall temperature of the preform, h is a heat transfer coefficient, and Tα is the air temperature. The heat transfer coefficients for inside and outside preform surfaces are computed based on empirically derived relationships of air velocity.

In the preferred embodiment, the calculated thermal profile of each cross sectional area of the final heated preform is input into a blow-molding module used to determine the stress/strain behavior of the material and simulate stretching of the heated preform. In other preferred embodiments, the calculated thermal profiles may be used for other types of modeling such as finite element analysis.

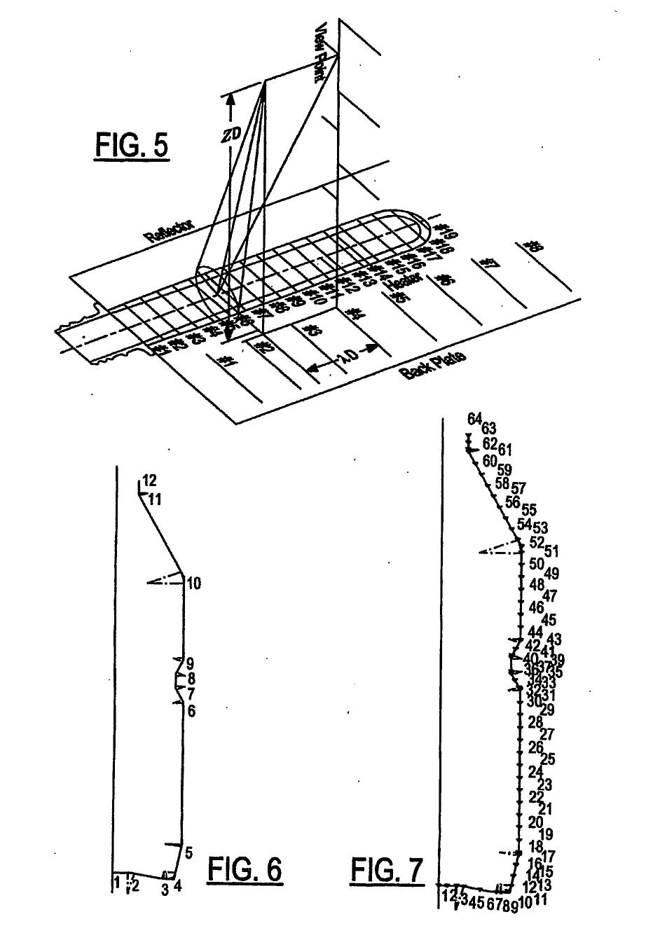

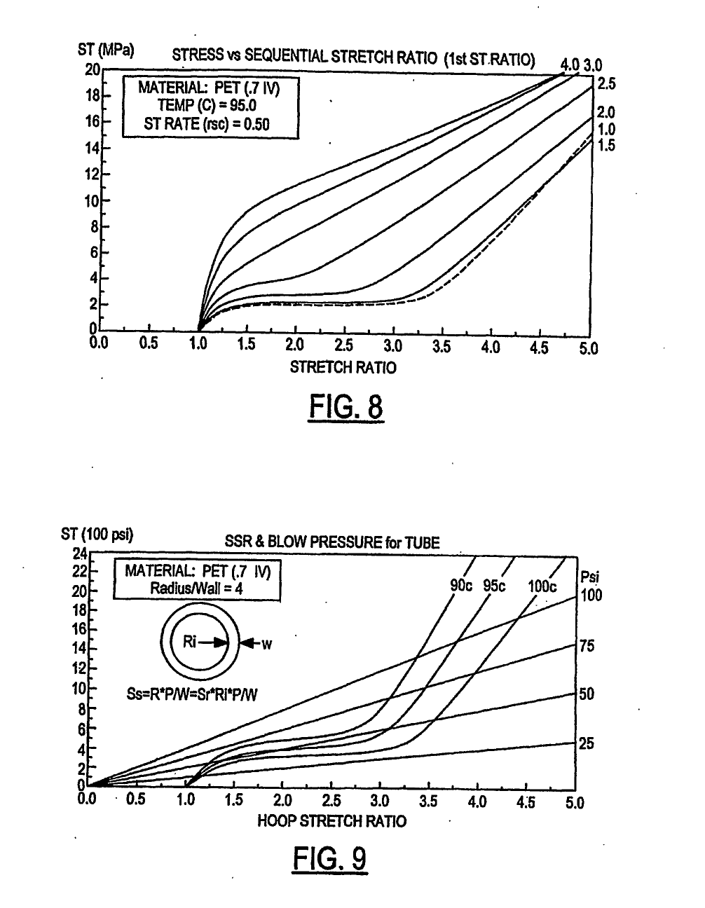

The heated preform is then blown into a container in a Simulate Stretch Blow Molding step 24 based upon the bottle geometry from the step 13, the preform temperature information from the step 23 and data from a Stress/Strain Behavior of Material step 25. The simulated blow molding proceeds to a Bottle Wall Thickness Profile step 26 where the thickness of each section of the prototype bottle is determined. The thickness profile can be used in a Calculate Barrier Properties step 27. In simulating steps 24-27, the bottle geometry is input into the model by defining heights, diameters, and radii of curvature at critical locations of the bottle. These areas of critical locations are defining points where transitional changes to a shape of the bottle are occurring (shown in FIG. 6). The intermediary sections are discretized into a plurality of sections (shown in FIG. 7) automatically by the computer program. Alternatively, the intermediary sections may be entered into the computer program. To determine how strain hardening occurs and to what extent, the model considers the effect of stretching rate, extent of uni-axial and bi-axial stretching, preform temperature and resin i.v. (i.e., intrinsic viscosity of resin) at each critical location or at each section. A relative stiffness factor is assigned to each section of the preform based on temperature and thickness. When applying a pressure or stress, the model determines which respective section will stretch and to what extent each respective section will stretch based upon a stress-strain curve of a respective material at a given temperature as it intersects an induced blowing temperature. As a result, an axial and hoop (diameter) orientation is computed for each respective section of the preform as the preform is blown into a bottle and the resultant thickness thereof. A graph of the stress-stretch curves (i.e., for axial stretch) and stretch-blow pressure curves (i.e., for hoop stretch) for a respective material are shown in FIG. 8 and 9, respectively.

A design optimization module is used to optimize a material distribution efficiency of the preform. A Preform Design Optimization Routine 28 can be used to optimize the preform geometry. The thickness profile from the step 26 is input to a Calculate Material Distribution Efficiency (MDE) step 29. The result of the step 29 is input to a Revise Preform Geometry to Maximize MDE step 30. The revised geometry is input into the Solve Energy Equations step 18 and the blowing process is simulated again. This optimization routine 28 can be repeated until the best possible MDE is achieved.

In accordance with the provisions of the patent statutes, the present invention has been described in what is considered to represent its preferred embodiment.

However, it should be noted that the invention can be practiced otherwise than as specifically illustrated and described without departing from its spirit or scope.

What is claimed is:

1. A method for simulating the heating of a plastic preform comprising the following steps:
inputting a preform geometry into a preform design program;
providing oven geometry and calculating spatial location of said preform through at least one oven;
providing heating information and calculating temperatures of primary and secondary heating sources;
solving energy equations based upon said preform geometry, said spatial location of said preform, said temperatures, cooling air and absorption spectra of a material of said preform; and
computing at least one cross sectional thermal profile of a final heated preform.

2. The method of claim 1 further comprising the step of providing a stress/strain behavior of said material and simulating stretch blow molding of said heated preform;

3. The method of claim 1 further comprising the step of generating a bottle geometry for a bottle design.

4. The method of claim 3 further comprising the step of determining a bottle wall thickness profile.

5. The method according to claim 1 including performing a design optimization routine.

6. The method according to claim 5 including incorporating the geometry of an existing preform to determine its fitness for use in a specific application.

7. The method according to claim 1 wherein said step of solving energy equations includes determining an emission spectra of said primary and secondary heating sources.

8. The method according to claim 1 wherein said step of solving energy equations includes determining an absorption radiation of said preform.

9. The method according to claim 8 wherein said step of determining said absorption radiation includes discretizing said preform into a plurality of blocks of a respective volume, wherein said absorption radiation is determined for each of said plurality of blocks.

10. The method according to claim 9 wherein said step of determining said absorption radiation includes determining a view factor, said view factor characterized as radiation spectra of said primary heating sources incident to each of said plurality of blocks of said preform at a respective oven location, said view factor provided by the formula
V_{f}=(1/π)∫dAₚ∫ Cos φ Cos θdAₕ/r²
here Aₚ is an area said preform, Aₕ is an area of a heater, φ is an angle between normal to a preform surface and an incremental area on said heater, θ is an angle between a normal to heater surface and an incremental area on said preform, and r is a distance between normal surface Aₚ and Aₕ.

11. The method according to claim 10 wherein said radiation spectra transmitted through a respective block of said preform is provided as an input for determining said absorption radiation incident to a next adjacent block.

12. The method according to claim 1 wherein said step of providing a stress/strain behavior further comprises discretizing said preform into a plurality of sections.

13. The method according to claim 12 wherein said step of providing a stress/strain behavior further comprises determining an axial orientation and hoop orientation.

14. The method according to claim 13 wherein said axial orientation and said hoop orientation is determined for each of said plurality of sections.

15. A method for the virtual prototyping of plastic containers comprising the following steps:
generating a bottle geometry for a bottle design;
inputting a preform geometry into a preform design program;
providing oven geometry and calculating spatial location of said preform through at least one oven;
providing heating information and calculating temperatures of primary and secondary heating sources;
solving energy equations based upon said preform geometry, said spatial location of said preform, said temperatures, cooling air and absorption spectra of a material of said preform; computing at least one cross sectional thermal profile of a final heated preform;
providing a stress/strain behavior of said material and simulating stretch blow molding of said heated preform; and
determining a bottle wall thickness profile.

16. A method for the virtual prototyping of plastic containers comprising the following steps:
generating a bottle geometry for a bottle design;
generating a preform design for said bottle by means of a preform design program;
providing oven geometry and calculating spatial location of said preform through at least one oven;
providing heating information and calculating temperatures of primary and secondary heating sources;
solving energy equations based upon said preform geometry, said spatial location of said preform, said temperatures, cooling air and absorption spectra of a material of said preform;
computing at least one cross sectional thermal profile of a final heated preform;
providing a stress/strain behavior of said material and simulating stretch blow molding of said heated preform; and
determining a bottle wall thickness profile.

17. An apparatus for simulating the heating of a plastic preform comprising:
means for inputting a preform geometry into a preform design program;
means for generating oven geometry, said oven geometry defining oven parameters for providing a heating source to a preform, said oven geometry including spatial locations of said preform within said oven geometry;
means for generating primary and secondary temperature heating sources for providing energy to said preform; and
a preform heating module for:
(a) solving energy equations based on inputs from said preform geometry, said spatial location of said preform, said temperature heating sources, cooling air and spectra of a material of said preform;
(b) computing at least one cross-sectional thermal profile of a final heated-preform.

18. The apparatus of claim 17 further comprising a blow-molding module for determining a stress/strain behavior of said material as a function of said temperatures derived in said preform heating module and simulating stretch blow molding of said final heated preform.

19. The apparatus of claim 17 further comprising a means for generating a bottle geometry for a bottle design.

20. The apparatus of claim 19 wherein said blow molding module determines a bottle wall thickness.

21. The apparatus of claim 17 further comprising a design optimization module for optimizing a material distribution efficiency of said preform.

22. An apparatus for virtual prototyping of plastic containers comprising:
means for generating a bottle geometry for a bottle design;
means for inputting a preform geometry into a simulation program;
means for generating oven geometry, said oven geometry defining oven parameters for providing a heating source to a preform, said oven geometry including spatial locations of said preform within said oven geometry;
means for generating primary and secondary temperature heating sources for providing energy to said preform;
a preform heating module for:
(a) solving energy equations based on inputs from said preform geometry, said spatial location of said preform, said temperature heating source, cooling air and spectra of a material of said preform;
(b) computing at least one cross-sectional thermal profile of a final heated preform;
a blow-molding module for:
(a) determining a stress/strain behavior of said material as a function of said temperatures derived in said preform heating module and simulating stretch blow molding of said heated preform;
(b) determining a bottle wall thickness; and a design optimization module for optimizing a material distribution efficiency of said preform.
